(19) United States
(12) Patent Application Publication
(10) Pub. No.: US 2018/0191228 A1
(43) Pub. Date: Jul. 5, 2018

(54) MAGNETIC APPARATUS HAVING ELECTRICALLY INSULATING LAYER

(71) Applicant: General Electric, Schenectady, NY (US)

(72) Inventors: Yong LIANG, Niskayuna, NY (US); James BRAY, Niskayuna, NY (US); Francis JOHNSON, Niskayuna, NY (US); John KRAHN, Niskayuna, NY (US); Vance ROBINSON, Niskayuna, NY (US); Manoj SHAH, Niskayuna, NY (US)

(73) Assignee: General Electric, Schenectady, NY (US)

(21) Appl. No.: 15/394,163

(22) Filed: Dec. 29, 2016

(51) Int. Cl. H02K 9/22; H02K 1/32; H02K 1/02; H02K 15/02; H01F 1/153; H01F 1/057

(52) U.S. Cl. CPC H02K 9/22; H02K 1/32; H01F 1/057; H02K 15/02; H01F 1/15308; H02K 1/02

(57) ABSTRACT

In one embodiment an apparatus can include a plurality of magnetic material layers. In one embodiment, an apparatus can include one or more electrically insulating layer, wherein the plurality of magnetic material layers and the one or more electrically insulating layer define a stacked up structure, wherein an electrically insulating layer of the one or more electrically insulating layer includes thermally conductive dielectric material.

The subject matter disclosed herein relates stacked structures in general and in particular a magnetic apparatus having a plurality of layers.

### BACKGROUND

The prior art sets forth various apparatus and methods employing deposited electrically insulating material. The prior art sets forth a method for producing free-standing diamond film having a surface area of at least 1000 square millimeters includes the following steps: providing a substrate; depositing, on the substrate, by chemical vapor deposition, a first layer of diamond over a surface area of at least 1000 square millimeters, and to a first thickness, the first layer being deposited at a first deposition rate; depositing, on the first layer, a second layer of diamond, over a surface area of at least 1000 square millimeters, and to a second thickness, the second layer being deposited at a second deposition rate; and releasing the diamond from the substrate; the second deposition rate being at least twice as high as the first deposition rate, and the first thickness being sufficiently thick to prevent the released diamond from bowing by more than a given distance.

### BRIEF DESCRIPTION

In one embodiment an apparatus can include a plurality of magnetic material layers. In one embodiment, an apparatus can include one or more electrically insulating layer, wherein the plurality of magnetic material layers and one or more electrically insulating layer define a stacked up structure, and wherein an electrically insulating layer of the one or more electrically insulating layer includes thermally conductive dielectric material.

### DRAWINGS

These and other features, aspects, and advantages of the present invention will become better understood when the following detailed description is read with reference to the accompanying drawings in which like characters represent like parts throughout the drawings, wherein:

FIG. 1 is a cross sectional view of an apparatus having one or more electrically insulating layer together with a diagram illustrating a heat dissipation temperature gradient of an apparatus.

FIG. 2 cross sectional view of an apparatus having a buffer layer between a magnetic layer and an electrically insulating layer;

FIG. 3 is a cross sectional view of an apparatus having a first stack subassembly adhered to second stack subassembly;

FIG. 4 is a cross sectional view of an apparatus having an electrically insulating layer including a pre-formed cut sheet;

FIG. 5 is a cross sectional view of an apparatus having an electrically insulating layer including a composite material;

FIG. 6 is a perspective assembly view of an apparatus provided by an electric motor having a stacked up structure;

FIG. 7 is a perspective view of an apparatus provided by an electric motor rotor having a stacked up structure; and

FIG. 8 is a cross sectional view of an apparatus provided by an electric motor rotor having an electrically insulating layer.

### DETAILED DESCRIPTION

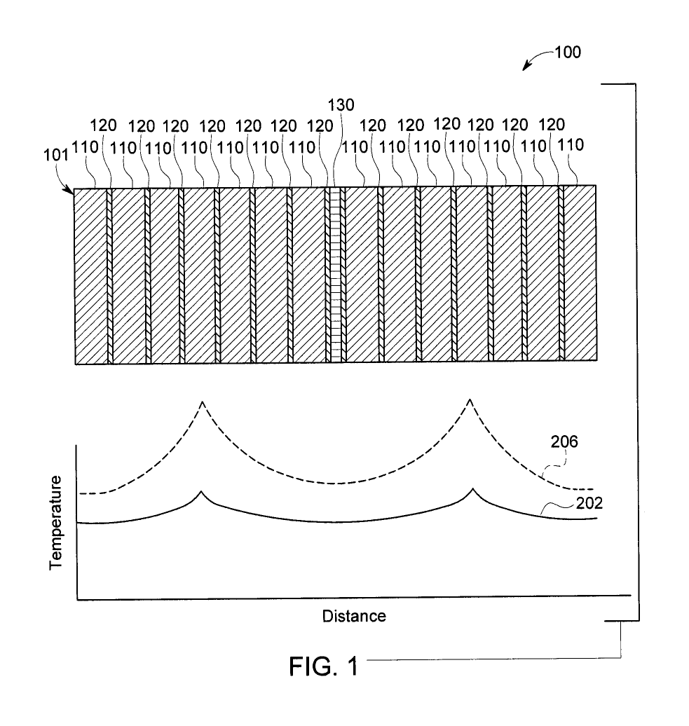

There is set forth herein in reference to FIG. 1 an apparatus defined by a stacked up structure. In one embodiment apparatus 100 can include a plurality of magnetic material layers 110. In one embodiment, apparatus 100 can include one or more electrically insulating layer 120, wherein the plurality of magnetic material layers and the one or more electrically insulating layer 120 define a stacked up structure 101 as shown in FIG. 1. In one embodiment, apparatus 100 can include one or more cooling layer 130 incorporated as part of a stacked up structure. In one embodiment apparatus 100 can be a magnetic field generating apparatus.

In one embodiment, magnetic material layers 110 can be formed e.g. of a transition metal, e.g. Fe, Co, or Ni. In one embodiment, magnetic material layers 110 can be formed e.g. of silicon steel, hyperco, or dual-phase magnetic materials. On one embodiment, magnetic material layers 110 can include e.g. crystalline, nanocrystalline, amorphous soft or permanent magnetic alloy. On one embodiment, magnetic material layers 110 can include e.g. iron silicon, iron-cobalt (e.g. hiperco, supermendur) or iron-nickel (permalloy). On one embodiment, magnetic material layers 110 can include e.g. a nanocrytalline alloys, e.g. FINEMET, Vitreperm, Nanoperm, and HiTPerm. On one embodiment, magnetic material layers 110 can be formed e.g. an amorphous soft magnetic alloy, e.g. an Fe-based alloys, Co-based alloy, an Fe—Ni based alloy including Metglas and Vitrovac. On one embodiment, magnetic material layers 110 can include alternative permanent magnetic material, e.g. Neodymium-Iron-Boron, Samarium Cobalt, hexaferrite, Alnico, or Cunife. To the extent magnetic and mechanical properties of the magnetic material layers 110 can be compromised during processes that may be used in some embodiments herein, e.g. chemical vapor deposition (CVD) diamond deposition at high temperatures, these properties can be recovered by post deposition treatments.

In one embodiment, a layer of the one or more electrically insulating layer 120 can include thermally conductive dielectric material. In one embodiment, each layer of the one or more electrically insulating layer 120 can include thermally conductive dielectric material.

In one embodiment, cooling layer 130 can include a thermally conductive metal, e.g. Copper (Cu). In one embodiment, one or more cooling layer 130 can involve air flow cooling layers which facilitate carrying heat out of apparatus 100 via air flow. In one embodiment, stacked up structure 101 can include any number of layers e.g. a total of tens to hundreds of layers, wherein the tens to hundreds of layers can be provided by magnetic material layers 110, one or more electrically insulating layer 120 and in one embodiment a cooling layer 130 every Nth layer, where N is the range from about 2 to 500.

Apparatus 100 in one embodiment can be provided by a magnetic motion force apparatus, e.g. an electric motor or component thereof.

Embodiments herein recognize benefits and advantages of apparatus 100 relative to alternative embodiments in which electrically insulating layer 120 does not include thermally conductive material. Apparatus 100 can include improved heat dissipation and therefore fewer cooling layers 130 relative to an alternative embodiment wherein electrically insulating layer 120 is absent of thermally conductive material.

Referring to gradient 202, illustrated in FIG. 1, gradient 202 is an expected temperature gradient of apparatus 100 through various layers of stacked up structure 101, where stacked up structure 101 includes electrically insulating layers 120 formed of thermally conductive dielectric material, e.g. for purposes of the present disclosure material having thermal conductivity of greater than about 10 W/m-K. Referring to gradient 206, gradient 206 is an expected temperature gradient of apparatus 100 through various layers of stacked up structure 101, where electrically insulating layer 120 provided by thermally conductive electrically insulating layers are replaced with electrically insulating layers with low thermal conductivity, e.g. for purposes of the present disclosure material having thermal conductivity of less than about 5 W/m-K.

Embodiments herein recognize that apparatus 100 characterized by reduced temperature gradiant 202 can exhibit improved performance of an alternative apparatus characterized by temperature gradiant 206. In one embodiment, an apparatus featuring a higher temperature gradiant 206 can be an apparatus corresponding to apparatus 100 with electrically insulating layers 120 formed of thermally conductive dielectric material replaced with electrically insulating layers having low thermal conductivity e.g. layers formed of such material as SiO2 or epoxy. Embodiment herein recognize that a key factor that limits a number of magnetic layers in a laminated magnet stack is the poor thermal conductivity of the dielectric layers. Embodiments herein recognize that advantages can be yielded by providing a magnet stack having an electrical insulator that has both high thermal conductivity and high electrical resistivity so that both Eddy current reduction and high thermal conduction can be realized in the laminated magnets. In one particular embodiment, diamond can be used as a thermally conductive electrical insulator. Embodiments herein recognize that diamond has very high thermal conductivity (˜1800 W/m·k) and electrical resistivity (>E10 Ohm·cm), low dielectric constant of approximately ˜5.6, thus satisfying these needs. Various embodiments herein use diamond or other material as an electrical insulating and thermally conductive layer in a laminated magnet to drastically improve the thermal conduction, thus enabling thicker laminated magnets to be constructed without additional cooling layers. The diamond or other material can be incorporated into the laminated magnets e.g. via thin film deposition, bonding, or polymer-diamond composite.

In one embodiment, thermally conductive electrically insulating material that be included in one or more electrically insulating layer 120 are summarized in Table A. In one embodiment, a thermally conductive material herein can be regarded as material having thermal conductivity of greater than about 10 w/m-k. In one embodiment, a thermally conductive material herein can be regarded as material having thermal conductivity of greater than about 100 w/m-k. In one embodiment, heat removal provided by layers 120 can be sufficient so that cooling layers 130 can be eliminated from apparatus 100 altogether. Providing apparatus 100 to include fewer cooling layers 130 can reduce the size and cost of apparatus 100. Reducing of a number of electrically conductive layers such as may be provided by cooling layers 130 can reduce the inducement of Eddy currents in apparatus 100 to further reduce heat in apparatus 100.

Embodiments herein recognize magnetic material layer 110 can generate magnetic fields which can induce Eddy currents in electrically conductive layers, such as may be provided by cooling layers 130. Inclusion of electrically insulating layers 120 having dielectric material can dissipate magnetic field through apparatus 100 to thereby reduce Eddy current generated in electrically conductive layers such as may be provided by cooling layers 130.

TABLE A
THERMALLY CONDUCTIVE DIELECTRIC MATERIALS

| | | THERMAL |
|---|---|---|
| | | CONDUCTIVITY (W/m- |
| MATERIAL | COMPOSITION | K) |
| Diamond | C | 1800 |
| Beryllium oxide | BeO | 250 |
| Silicon carbide | SiC | 250 |
| Boron nitride | BN | 740 |
| Aluminum nitride | AIN | 180 |

In one embodiment, materials of Table A can be lightweight materials of reduced weight relative to alternative thermally insulating dielectric materials. Inclusion of lightweight materials can provide various advantages e.g. increased air buoyancy in the case of apparatus 100 is configured for airborne use (e.g. for use in an electric motor of a jet engine), and increased speed in the case of use in moving apparatus (e.g. for use in an electric motor for any application).

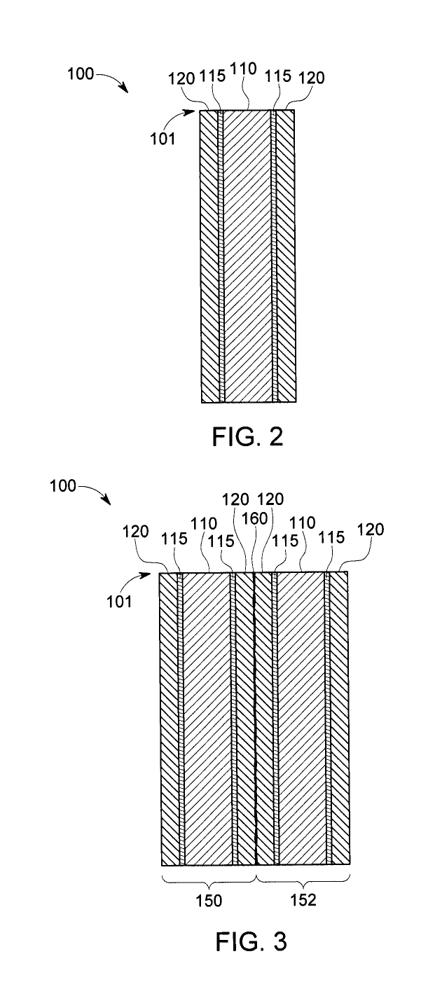

A method of forming apparatus 100 in one embodiment is described with reference to FIG. 2. As illustrated with reference to FIG. 2 a buffer layer 115 can be formed on magnetic material layer 110 and electrically insulating layer 120 including diamond can be formed on buffer layer 115. Embodiments herein recognize that transition metals such as Fe, Co, and Ni (which can be included in magnetic material layer 110) can act as catalysts that convert diamond into graphite during depositing at high temperatures, which would thus adversely affect the targeted material properties of electrically insulating layer 120. A presence of buffer layer 115 can prevent conversion of diamond into graphite where electrically insulating layer 120 includes diamond. In one embodiment, buffer layer 115 can be a thin layer (e.g. less than 10 microns) and include e.g. W, Mo WCₓ, MoC, SiC, WNₓ, MoNₓ. In one embodiment, buffer layer 115 can be deposited on magnetic material layer 110, using physical vapor deposition (PVD), CVD, or electroplating method. With buffer layer 115 formed on magnetic material layer 110, electrically insulating layer 120 can be formed on buffer layer 115. Where electrically insulating layer 120 includes e.g. diamond, electrically insulating layer 120 in one embodiment can be formed on buffer layer 115 using microwave chemical vapor deposits (MVCVD) or hot filament based CVD.

Referring to the fabrication method set forth in reference to FIG. 2 fabrication of apparatus 100 can include thin film deposition. Thin diamond or other material forming layer 120 can deposited on the magnetic layer using methods such as plasma enhanced CVD hot-filament based CVD and the like. Embodiments herein recognize that embodiments herein wherein electrically insulating layer 120 includes diamond can be subject to performance degradation owing to the catalytic effect. To avoid catalytic effect from e.g. Fe or Co that can convert diamond to graphite, and/or carbide formation in the magnetic layer during diamond deposition, a buffer layer 115 which can be a thin buffer layer can be first deposited on magnetic material layer 110. Buffer layer 115 can be formed of e.g. tungsten, molybdenum, tungsten carbide, molybdenum carbide, tungsten nitride, molybdenum nitride, and the layer thickness of buffer layer 115 in one embodiment can be vary from about one hundred nanometers to about a few micrometers.

Diamond deposition in one embodiment can be conducted at high temperatures using hydrogen and methane as the precursor gases where methane serves as the source of carbon for diamond. Carbon has five known isotopes, among them carbon-12 and carbone-13 are stable and make up nearly 99% and 1% of all natural carbons, respectively. It is known that presence of carbon-12 and carbon-13 affects the thermal conductivity of diamond. Diamond thermal conductivity can be increased further by reducing or eliminating carbon-12 or carbon-13 in diamond. Accordingly, in one embodiment, electrically insulating layer 120 can be formed of isotopically pure carbon 12 diamond. In one embodiment, electrically insulating layer 120 can be formed of isotopically pure carbon 13 diamond.

In one embodiment in reference to FIG. 2, magnetic material layers 110 can be provided by preformed rigid or flexible layers that can be cut to a desired size and shape using mechanical or laser cutting process.

Referring to FIG. 3 there is illustrated a method for formation of apparatus 100 wherein a first stack subassembly 150 having a magnetic material layer 110 and an electrically insulating layer 120 is bonded to a second stack subassembly 152 having a magnetic material layer 110 and an insulating layer 120. For bonding of the stack subassemblies 150, 152 an electrically insulating layer 120 of first stack subassembly 150 can be bonded to an electrically insulating layer 120 of a second stack subassembly 152. An electrically insulating layer 120 of first stack subassembly 150 can be bonded to an electrically insulating layer 120 of a second stack subassembly 152 with use of adhesive layer 160 applied between surfaces of insulating layers 120 of opposing stack subassemblies 150, 152. Adhesive layer 160 in one embodiment can include e.g. a lower viscosity adhesive, e.g. epoxy, silicone, polycarbonate, or acrylic. Adhesive layer 160 in one embodiment can be a thin adhesive layer and can include a thickness in one embodiment, e.g. of greater than or less than 10 microns. In one embodiment adhesive layer can be less than 1 micron so that its presence minimally impedes heat flow. In one embodiment adhesive layer 160 can be eliminated and the stack subassemblies 150, 152 can be laminated together by way of mechanical enforcement. Referring to FIG. 3 apparatus 100 as shown in FIG. 2 diamond coated layers can be stacked together via mechanical enforcement, or using adhesive layer 160. The thickness of the adhesive layer 160 can be very thin so that the thermal resistance introduced by this layer is negligible.

Embodiments herein recognize that because of surface roughness of layers 120 after formation of layers 120, air gaps may be present when stack subassemblies 150, 152 are bonded together. Adhesive layer 160 can be adapted to eliminate air gaps between electrically insulating layers of first and second stack subassemblies. Use of lower viscosity adhesives can facilitate elimination of air gaps. Skilled artisans will recognize that additional stack subassemblies can be added to the structure shown in FIG. 3 in the manner of the adding of stack subassembly 152 to stack subassembly 150.

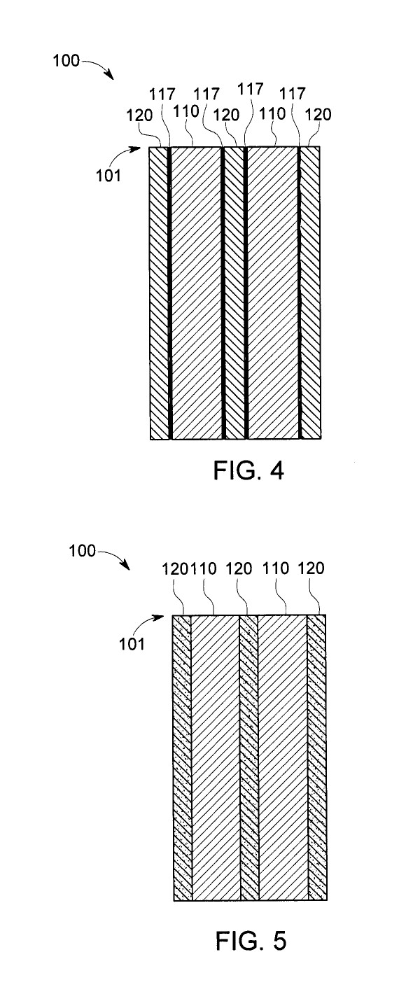

FIG. 4 illustrates an apparatus formation method wherein electrically insulating layers 120 can be formed from prefabricated rigid or flexible sheets (membranes) of electrically insulating material, e.g., prefabricated diamond sheets. In the embodiment of FIG. 4 insulating layers 120 can be laser cut from diamond sheets using a laser cutting process. Surfaces of electrically insulating layers 120 can be functionalized using plasma treatment, photochemical reaction, etc. for stronger diamond-polymer interaction so that interface thermal conduction is increased. In the embodiment of FIG. 4 an adhesive layer 117 can be provided between each magnetic material layer 110 and each electrically insulating layer 120. In reference to FIG. 4 there can be provided in one embodiment lamination of a layer 120 including a preformed diamond membrane with a magnetic material layer 110. In one embodiment, an adhesive layer 117 which can be a thin adhesive layer can be placed between layer 110 including a sheet and the magnetic material layer 110. At an elevated temperature a press can be applied to laminate one or more electrically insulating layer 120 with one or more magnetic material layer 110 using adhesive layer 117. The adhesive layer can be formed of various materials e.g. including but not limited to epoxy, silicone, polycarbonate, acrylic, or other polymer formulations. The adhesive layer in one embodiment can be less or greater than 10 microns and in one embodiment can be less than about 1.0 micron so that its presence minimally impedes heat flow across the interface. Regarding the method set forth in reference to FIG. 4 the method set forth in reference to FIG. 4 can involve lamination of free standing diamond sheets with magnetic material layers. An adhesive layer 117 can be placed between diamond sheets and the magnetic material layers, and elevated temperature and press can be applied to attach electrically insulating layers 120 formed of diamond sheets to magnetic material layers 110. The thickness of the adhesive layer 117 can be thin so that thermal resistance introduced by adhesive layer 117 is negligible.

FIG. 5 illustrates a formation method wherein electrically insulating layers 120 can include a composite layer. In one embodiment a composite layer forming electrically insulating layer 120 can include a polymer diamond composite. In one embodiment a composite material forming electrically insulating layer 120 can include a resin/epoxy with embedded diamond particles for higher thermal conductivity. In one embodiment, a diamond particle surface can be functionalized via plasma treatment, photochemical reaction, etc. that activates the diamond surface, resulting in better diamond-polymer interaction and higher interface thermal conductivity. In one embodiment, a composite material forming electrically insulating layer 120 can include more than about 30 percent diamond powder (by volume) for increased heat percolation. For forming an electrically insulating layer 120 including a polymer diamond composite diamond powders can first be functionalized to promote interaction between diamond powder surfaces and polymer. A resulting polymer diamond composite can then be coated to magnetic material layer 110 using a coating processes, e.g., spray coating, painting on, and the like. Referring to the method set forth in reference to FIG. 5 the method can include coating of polymer-diamond composite onto magnetic material layer 110. Diamond powders can be first functionalized that so good interaction between diamond surface and polymer can be established. The polymer-diamond composite can then be coated to the magnetic material layers 110. In one embodiment a density of the diamond powders in polymer can be maintained at a sufficiently high level so that heat from the magnetic material layers can be percolated through the composite layer for heat dissipation. The thermal conductivity of the polymer-diamond composite, while not as high as in embodiments where electrically insulating layers 120 can be formed of pure diamond, can still be significantly higher than in the case of electrically insulating layer 120 being replaced by a layer formed of a pure polymer. In one embodiment, electrically insulating layer 120 where provided by a composite material can include particles formed of material other than diamond. Electrically insulating layer 120 can be an electrically insulating thermally conductive polymer composite material having particles of one or more of the following materials selected from the group consisting of diamond, beryllium oxide, silicon carbide, boron nitride, and aluminum nitride. The embodiment of FIG. 5 can feature fabrication advantages. For example given bonding characteristics of certain composite materials, the method set forth in reference to FIG. 5, wherein electrically insulating layers 120 can be formed of a polymer composite, the method as set forth in reference to FIG. 5 can reduce or eliminate use of adhesive layers and/or lamination processes in the fabrication of stacked up structure 101.

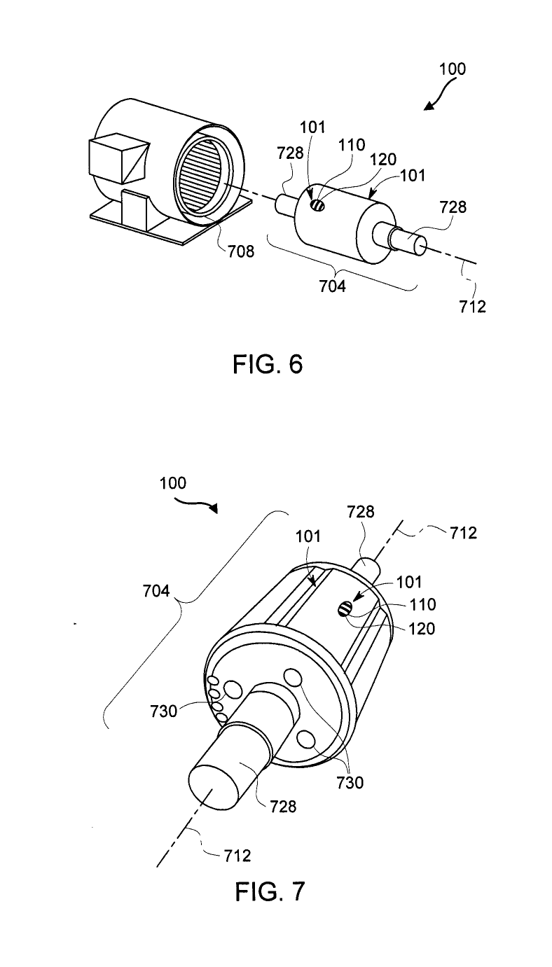

In one embodiment, as shown in FIG. 6 apparatus 100 can be provided by an electric motor and stacked up structure 101 can define a rotor 704 of an electric motor. Referring to FIG. 6, apparatus 100 provided by an electric motor can include a rotor 704 and a stator 708 in which rotor can rotate. Apparatus 100 provided by an electric motor can include a central axis 712 about which rotor 704 can rotate.

As shown in FIG. 7 stacked up structure 101 can include layers such as layers 110 and 120 that can extend generally in a plane transverse to central axis 712 and can be stacked in a direction generally coextensively with central axis 712 to define rotor 704. Rotor 704 in one embodiment can include one or more cooling channels 730 extending lengthwise there through at locations offset from but extending generally parallel to central axis 712. Shown on a scale for illustrative purposes, it will be understood that stacked up structure 101 can have any number of layers, e.g. tens to hundreds of layers as set forth herein.

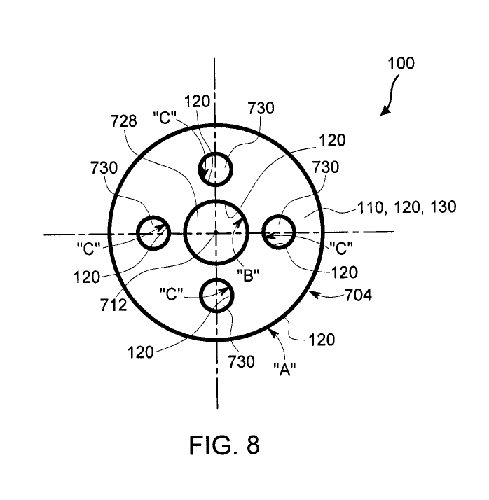

In one embodiment, as shown in FIG. 8 layers e.g. layers 110, 120 where layers 110, 112 define a rotor 704 can include a circular perimeter 722 and can include central apertures 728 to accommodate affixation of a bearing 726.

FIGS. 6-8 illustrate apparatus 100 having layers of thermally conductive electrically insulating layers defining stacked up structures with layers stacked in a direction of a central axis 712. In addition to or alternatively to such use apparatus 100 can include electrically insulating layers 120 formed of thermally conductive material e.g. as shown in FIG. 8 that do not form a stacked up structure and/or which do not extend generally in a plane transverse to central axis 712.

Referring to FIG. 9 apparatus 100 can provide heat reduction with one or more of electrically insulating layer 120 at “A” formed on an outer peripheral wall of rotor 704, electrically insulating layer 120 at “B” formed on an inner peripheral wall of a central bore of rotor 704 defined by central apertures 728 of layers defining a stacked up structure 101, or layer 120 at “C” formed on an inner peripheral wall of one or more cooling channels 730 extending lengthwise through rotor 714. Layer 120 at “A” in one embodiment can define a cylinder having a central axis co-located with central axis 712. Layer 120 at “B” in one embodiment can define a cylinder having a central axis co-located with central axis 712. Layer 120 at “C” in one embodiment can define a cylinder having a central axis offset with respect to but running generally parallel with central axis 712. Layer 120 at “A” layer 120 at “B” and layer 120 at “C” extend in directions that are generally parallel to a direction of central axis 712. Layer 120 at “A” layer 120 at “B” and layer 120 at “C” can extend in directions that are generally parallel to a direction of central axis 712 can be thermally conductive electrically insulating layers as set forth herein. Layer 120 at “A” layer 120 at “B” and layer 120 at “C” can be formed of flexible preformed material members that can be bended into various shapes. In another embodiment, layer 120 at “A” layer 120 at “B” and layer 120 at “C” can be formed of polymer diamond composite material that can be coated on a supporting surface by a coating process, e.g. spray coating, paining on, and the like. A polymer diamond composite for use in a structure as set forth in FIG. 8 can have properties of the polymer diamond composite as set forth in the embodiment of FIG. 5. Layer 120 at “A” layer 120 at “B” and layer 120 at “C” can be formed to be thermally coupled to one or more cooling layer 130 as set forth herein which one or more cooling layer 130 can extend generally transverse to central axis 612 as set forth herein. Such thermally coupling can facilitate removal of heat from apparatus 100.

Structural features as shown in the electrical motor embodiment of FIG. 6-7 can be combined with the structural features as shown in the embodiment of FIG. 8. In one embodiment an electrical motor can incorporate electrically insulating layers 120 formed of thermally conductive material in a stacked up structure 101 as shown in FIGS. 6 and 7 as well as one or more electrically insulating layer 120 formed of thermally conductive material arranged as shown in FIG. 8. In one embodiment an electrical motor can incorporate electrically insulating layers 120 in a stacked up structure 101 as shown in FIGS. 6 and 7 but without one or more electrically insulating layer 120 formed of thermally conductive material arranged as shown in FIG. 8.

In on embodiment an electrical motor can include one or more electrically insulating layer 120 arranged as shown in FIG. 8 and can include a stacked up structure having the features of stacked up structure 101 except with electrically insulating layer 120 formed of thermally conductive material replaced with an alternative electrically insulating material that has low thermal conductivity e.g. SiO2, epoxy, or the like.

Technical effects can include improved design of apparatus for use in applications where there is generation of a magnetic field. Improved designs herein can facilitate e.g. reduced heat, reduced weight, in which a magnetic field can be generated.

This written description uses examples to disclose the invention, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

1. An apparatus comprising:
a plurality of magnetic material layers; and
one or more electrically insulating layer, wherein the plurality of magnetic material layers are the one or more electrically insulating layer define a stacked up structure, wherein an electrically insulating layer of the one or more electrically insulating layer includes thermally conductive dielectric material;
wherein a layer of the one or more electrically insulating layer is disposed intermediate of a first layer and a second layer of the plurality of magnetic material layers.

2. The apparatus of claim 1, wherein the electrically insulating layer includes diamond.

3. The apparatus of claim 1, wherein the thermally conductive dielectric material is selected from the group consisting of isotopically pure carbon-12 diamond and isotopically pure carbon-13 diamond.

4. The apparatus of claim 1, wherein the thermally conductive dielectric material is selected from the group consisting of diamond, beryllium oxide, silicon carbide, boron nitride, and aluminum nitride.

5. The apparatus of claim 1, wherein the electrically insulating layer includes thermal conductivity of greater than about 10 W/m-K.

6. The apparatus of claim 1, wherein the electrically insulating layer includes thermal conductivity of greater than about 100 W/m-K.

7. The apparatus of claim 1, wherein the electrically insulating layer includes a polymer diamond composite.

8. The apparatus of claim 1, wherein the apparatus includes a buffer layer between a magnetic material layer of the plurality of magnetic material layers and the electrically insulating layer, wherein the buffer layer is formed on a magnetic material layer of the plurality of magnetic material layers, and wherein the electrically insulating layer is deposited on the buffer layer.

9. The apparatus of claim 1, wherein the electrically insulating layer is formed of a diamond sheet, and wherein the apparatus includes an adhesive layer for adhering the electrically insulating layer to a magnetic material layer of the plurality of magnetic material layers.

10. The apparatus of claim 1, wherein the stacked up structure includes a first stack subassembly and a second stack subassembly, wherein the first stack subassembly includes a magnetic material layer and deposited electrically insulating layer, wherein the second stack subassembly includes a magnetic material layer and deposited electrically insulating layer, wherein the first stack subassembly is bonded to the second stack subassembly.

11. The apparatus of claim 1, wherein the magnetic material layer includes magnetic material selected from the group consisting of soft magnet alloy and permanent magnet alloy.

12. The apparatus of claim 1, wherein the magnetic material layer includes magnetic material selected from the group consisting of crystalline magnet alloy, nanocrystalline magnetic alloy, amorphous soft magnetic alloy, permanent magnetic alloy, iron silicon, iron-cobalt and iron-nickel.

13. The apparatus of claim 1, wherein the magnetic material layer includes nanocrystalling magnetic material selected from the group consisting of FINEMET, Vitreperm, Nanoperm, and HiTPerm.

14. The apparatus of claim 1, wherein the magnetic material layer includes soft amorphous magnetic material selected from the group consisting of Fe-based alloys, C-based alloys, and Fe—Ni based alloys.

15. The apparatus of claim 1, wherein the magnetic material layer includes permanent magnet magnetic material selected from the group consisting of Neodymium-Iron-Boron, Samarium Cobalt, hexaferrite, Alnico and Cunife.

16. The apparatus of claim 1, whereas the apparatus is an electric motor, and wherein the stacked up structure defines a component of the electric motor.

17. The apparatus of claim 1, wherein the apparatus is an electric motor having a stator and a rotor adapted to rotate about a central axis, wherein the stacked up structure defines the rotor, and wherein the apparatus further includes one or more thermally conductive electrically insulating layer formed at one or more of the following selected from the group consisting of (a) an outer peripheral wall of the rotor, (b) an inner peripheral wall of a central bore of the rotor, (c) an inner peripheral wall of a cooling channel extending lengthwise through the rotor.

18. A method comprising:
forming a stacked up structure having one or more electrically insulating layer and a plurality of magnetic material layers, wherein a layer of the one or more electrically insulating layer includes thermally conductive dielectric material; and
wherein the forming a stacked up structure is performed so that a layer of the one or more electrically insulating layer is disposed intermediate of a first layer and a second layer of the plurality of magnetic material layers.

19. The method of claim 18, further including depositing an electrically insulating layer of the one or more electrically insulating layer on a buffer layer, and wherein the method includes forming the buffer layer on a layer of the plurality of magnetic materials layers.

20. The method of claim 18, wherein forming one or more electrically insulating layer includes depositing a composite material on a layer of the plurality of magnetic material layers.

21. The method of claim 18, wherein forming one or more electrically insulating layer includes laser cutting material from a preformed rigid sheet of material.

22. The method of claim 18, wherein the method includes forming a first stack subassembly having a first electrically insulating layer, forming a second stack subassembly having a second electrically insulating layer and bonding the first stack subassembly to the second stack subassembly using an adhesive that bonds the first electrically insulating layer to the second electrically insulating layer.

23. The method of claim 18, whereas the method includes growing an electrically insulating layer of the one or more electrically insulating layer on a magnetic material layer of the plurality of magnetic material layers using a thin film deposition process.

24. The method of claim 18, wherein the method includes one or more of the following selected from the group consisting of (a) depositing an electrically insulating layer of the one or more electrically insulating layer, (b) laser cutting a sheet of material to define an electrically insulating layer of the one or more electrically insulating layer, and (c) performing a coating on process to define an electrically insulating layer of the one or more electrically insulating layer.

25. An electric motor comprising:
a stator;
a rotor adapted to rotate about a central axis; and
a thermally conductive electrically insulating layer formed at one or more of the following selected from the group consisting of (a) an outer peripheral wall of the rotor, (b) an inner peripheral wall of a central bore of the rotor, (c) an inner peripheral wall of a cooling channel extending lengthwise through the rotor.

26. The electric motor of claim 25, wherein the thermally conductive electrically insulating layer is a polymer composite embedded with particles of one or more of the following materials selected from the group consisting of diamond, beryllium oxide, silicon carbide, boron nitride, and aluminum nitride.

27. The electric motor of claim 25, wherein the rotor is defined by a stacked up structure having a thermally conductive electrically insulating layer.
